(19) United States
(12) Patent Application Publication
(10) Pub. No.: US 2010/0136174 A1
(43) Pub. Date: Jun. 3, 2010

(54) DAIRY CREAM PRODUCTS & METHODS

(76) Inventor: Kelly K. Cox, Cloverdale, CA (US)

Correspondence Address: HUGHES LAW FIRM, PLLC, 5160 Industrial Place,#107, Ferndale, WA, 98248-7819, US

(21) Appl. No.: 12/472,145

(22) Filed: May 26, 2009

Related U.S. Application Data
(60) Provisional application No. 61/055,932, filed on May 23, 2008.

(51) Int. Cl. A23C 13/14; A23C 17/00; A23C 21/00

(52) U.S. Cl. 426/71; 426/570; 426/519

(57) ABSTRACT

A dairy cream related food product comprising dairy cream and a quantity of what is designated a “mother blend”. The mother blend is partially made up of a liquid component of water and/or MFGM buttermilk, and/or whey which comprises the mother blend liquid component. The other part of the mother blend is a quantity of a hydrocolloid fiber ingredient that is intimately mixed in the process with the mother blend liquid. By varying the quantities of the ingredients and also in some instances adding additional ingredients to the end product, variations of the dairy cream related food products are created.

### RELATED APPLICATIONS

This application claims priority benefit of U.S. Ser. No. 61/055,932, filed May 23, 2008. Also, this application claims priority benefit of, and incorporates by reference, the information in another patent application by the same inventor of this patent application, which other patent application is entitled “BUTTER RELATED FOOD PRODUCT AND METHOD”, filed on Apr. 4, 2008, Ser. No. 12/098,392, which has or may have information that would be relevant to the subject matter of the present patent application. Accordingly, my previously filed patent application is presented as an attachment to the present application.

### BACKGROUND OF THE DISCLOSURE

a) Field of the Disclosure

The present invention relates to dairy cream, and more specifically to dairy cream related products and the methods of making dairy cream related products, and also utilizing them in various ways

b) Background Information

As an introductory comment, the term “dairy cream,” as used in this patent application, is meant to comprise the liquid fat portion that is separated from the total milk which is produced by a dairy cow or some other mammal. In the prior art, dairy cream is commonly used in various ways, and some of these are the following:
i) First dairy cream is commonly used by adding the dairy cream by itself to a cup of coffee or other beverages.
ii) Second, dairy cream is sometimes used as a preliminary ingredient combined with another related liquid or powdered ingredient which is then added to a person's coffee or other beverages where the regular cream is mixed with skim non-fat milk or some other ingredients (this type of cream related food products being sometimes called “half and half” or “half 'n half”).
iii) Third, dairy cream is treated to be transformed into “whipped cream”. For example, when the whipped cream product is made in the kitchen, it is common that the cream is mixed with a portion of one or more ingredients, such as a relatively small amount of sugar, and possibly vanilla or some other ingredient(s). Then this mixture continues to be mixed until it is transformed into the foam-like product to be used, for example, as a topping to add flavor to the main dessert.
iv) A fourth application of dairy cream in the prior art is to transform the dairy cream into making frosting. This is commonly done by adding a quantity of sugar and/or other sweetener, and possibly other ingredients to the regular dairy cream, and this is mixed for a sufficiently long period of time so that it is in a solid form of a putty-like consistency where it can be spread over a cake or other baked product.

### SUMMARY OF THE DISCLOSURE

In the method of making a dairy cream related food product, there is provided first and second main components. The first component is a quantity of dairy cream and the second is a quantity of a mother blend. The mother blend in turn comprises a mother blend liquid component made up of water and/or other ingredients and also a quantity of a hydrocolloid fiber ingredient. The components of the mother blend are mixed together, and that mixture is then mixed with the dairy cream to form the basic dairy cream related food product. In various other embodiments other ingredients can be added.

### DESCRIPTION OF THE EMBODIMENTS

The embodiments of the present invention relate primarily to what can be termed dairy cream related products.

In large part these dairy cream related products have three important features, namely:
i) The first and probably most important feature of the embodiments of the present invention are that these can clearly qualify as “functional foods” which means that they have health benefits beyond (and/or in addition to) basic nutrition. The main reason for this is in large part that in the embodiments of the present invention there is approximately 35% less saturated fat, calories and cholesterol than regular cream products.
ii) The second important feature is that the quality of the dairy products of the present invention is at a minimum comparable to corresponding regular dairy products and in some arrangements clearly superior in that at least some of the embodiments of the present invention have a distinctive sweet taste and an enhanced dairy flavor beyond what would be present in regular dairy cream.
iii) The third important feature of the end product or products is that these end products can easily be made to be ostensibly quite similar to a presently existing regular dairy cream product or products and can be used as a replacement for regular cream in various ways, such as coffee cream, whipping cream, cream used in making frosting, etc.

In the following text, for convenience the dairy cream related food product or products shall simply be referred to in the following text as a functional “cream related product” or functional “cream related products”.

Each of the cream related products comprises two basic components, namely:

i) the dairy cream; and

ii) the mother blend.

The term “mother blend” is a term used by the inventor and relates to a mixture of two or more components or ingredients which are mixed with the dairy cream (and possibly some other additive) to produce the dairy cream related product.

As indicated above, the dairy cream component of the present invention is the cream that is separated from the milk produced by a cow or other mammal. This cream component could be, for example, approximately one half of the total end product by weight with the other one half of the total weight being that of the mother blend liquid, but there could be substantial variations for this.

The mother blend which is mixed with the dairy cream comprises a mother blend liquid component of water and/or MFGM buttermilk, whey, and a quantity of a hydrocolloid fiber ingredient that is intimately mixed with the mother blend liquid component so that the mother blend liquid component with the fiber ingredient are in a colloidal state.

Then, to complete the making of the dairy cream related food product, the quantity of cream is mixed with the mother blend to form the cream related product.

To explain briefly what this MFGM buttermilk is, when cream is churned into butter there is what we could call a “bi-product” that is produced in the churning operation, which is called “buttermilk” or “buttermilk MFGM” (which stands for “milk-fat-globule-membrane). In years past, it was more common to have this buttermilk bottled and sold as a product in its own right under the generic name “buttermilk”. However, that trend is apparently part of the past, and typically this buttermilk MFGM is now simply drained off either as a waste product or utilized in some food processes such as conditioning ice cream. But for the most part it simply goes down the drain. Also, whey in the liquid state could be part of the liquid component.

For the moment, to give a brief description of one example of this embodiment, let us assume that the mother blend comprises only the water and the inulin. Inulin is a soluble dietary fiber, and when it is mixed with the water the inulin is distributed throughout the water. Then when the water is mixed somewhat vigorously, the inulin in the water is mixed with the water into a colloidal condition.

The next step then is to combine the cream with the mother blend. This would be a mixing process which should be done rather gently so that the final mixture does not have air bubbles or broken MFGM disbursed therein. Then this end product should be treated in a manner that regular cream would normally be treated in a kitchen or the like, being kept properly cooled, etc.

There are obvious variations in this. For example, the cream component does not necessarily have to be comprised only of cream. The cream component could be half cream and half milk (i.e., half n half). Then the mother blend would be, for example, 100 grams of water and 150 grams of inulin. This cream product has the previously mentioned distinctive sweet taste. The following is an example of this.
EXAMPLE: The cream component used in this example is “half n half” (i.e., half cream and half milk), and an amount of the “half n half” which is to be combined is 236 grams. The mother blend is made up 100 grams of water and 150 grams of inulin, and the water and the inulin are first mixed somewhat vigorously so that the inulin is properly disbursed throughout the water to be transformed into a colloidal condition. Then the mother blend liquid is gently mixed with the “half-n-half” cream component. The end product has a sweet cream-like taste and also a fine texture.

To provide information on inulin, inluin is a soluble dietary fiber derived from possibly as many as about 30,000 different vegetation plants from around the world. It is a mixture of non-digestible fructose units linked together by (2-1) linkages terminated by a glucose unit. The primary source which is used commercially is derived from chicory root or Jerusalem Artichokes. Inulin is a generic term, and it is a fructo-ologasicride and considered to be a hydrocolloid that is refined with a hot water process. Inulin is a white powder that has a slightly sweet flavor. However, it is not considered a sugar, and it is diabetic friendly; it doesn't affect glycemic levels and does not cause stimulation of insulin excretion.

However, while inulin is the desired dietary fiber, it is to be understood that there are other dietary fibers that are within the category of being a “hydrocolloid” and could be included as candidate, possible as one of a plurality of dietary fibers that make up the total dietary fiber.

The following five hydrocolloids would be some of the more desirable hydrocolloids, these being the following:
Algin
Locust bean gum
Guar
Xanthan
Pectin

The following hydrocolloids are in the category which would possibly be a step below those given above, this being the following:
Arabic gum
Karaya
Oat
Pysllium
Chitosan
Carrageenan
Agar

Finally, there are yet other hydrocolloids, and these are ones which present analysis believes to be less desirable, this being the following:
Ghatti
Guince
Sapote
Watsonia
Tamarind
Tragacanth
Furcelleran
Dextran
Chondritin sulfate
Xylan
Propol

### Relative Quantities of the Ingredients.

In the development of the embodiments, various percentages by weight of combinations of ingredients were analyzed, and among these are the following:

Dairy

| Cream | Inulin | Water |
|---|---|---|
| 64% | 22% | 14% |
| 52 | 30 | 18 |
| 75 | 24 | 1 |
| 77 | 5 | 18 |
| 69 | 30 | 1 |
| 94 | 5 | 1 |

The results were that the ratios of 64% dairy cream, 22% inulin and 14% water turned out to be quite satisfactory. Also, the formulation of 52% dairy cream, 30% inulin and 18% water were tried and these also resulted in a quality end product.

In the formulation of 77% dairy cream, 5% inulin and 18% water, the dietary benefits of the end product were substantially compromised, and there was something of an unwanted excess of water.

In the formulation where there was 69% dairy cream, 30% inulin and 1% water, the overall texture of the cream-related product was what could be described as “gritty” or like raw pancake batter.

Both the 22% inulin and 14% water mixture and also the 30% inulin and 18% water mixture were also quite satisfactory. The water to inulin ratios for the two mixtures given in the prior sentence are 1 to 1.57 and 1 to 1.67, respectively. Accordingly, a middle compromise would be approximately a 1 to 1.6 ratio of water to inulin to obtain the quite adequate mixture.

However, these water-to-inulin ratios given by weight in the above paragraph could possibly be broadened out somewhat so that the ratios could be as low as 1 to 1.5, 1 to 1.4, or 1 to 1.3, or 1 to 1.2, or 1.1, or possibly lower when an excess of water could be tolerated. Then the ratios could possibly be broadened to 1 to 1.7, 1 to 8, 1 to 1.9, 1 to 2, 1 to 2.2, 1 to 2.4, 1 to 2.6, 1 to 2.8, 1 to 3 or possibly higher. However, the quality of the end product would likely be diminished in some respects with substantial departure from the 1 to 1.6 ratio.

In comparing the two more optimized examples (one of which has 52% cream, 30% inulin and 18% water) with a second ratio mixture (64% cream, 22% inulin and 14% water), the lowered amount of cream in the first example would cause the end product to have less of a cream taste, but on the other hand it would likely get more of the benefits of having the benefits of inulin. Further, it would simply be a reversal of these if we go to the example of higher percentage of cream so that there would be more of the cream taste, but with less desirable results in compromising the benefits of having more inulin as an ingredient.

In one of the tests where there was 77% cream, 5% inulin and 18% water, some benefit can be obtained, but the main downside is that there would be an unnecessarily large amount of water present.

### Lactated Dairy Product

Lactose is a disaccharide (i.e., a complex sugar) which can be found in dairy products, but some people cannot tolerate it. Accordingly, to remedy this, in the present embodiment(s), a lactase enzyme is added to the dairy cream, either before pasteurization of the dairy cream, or after pasteurization of the dairy cream (post-pasteurization being the preferable version of that method). This is accomplished by adding a lactate enzyme which produces the effect of breaking down the lactose into types of sugar, namely glucose and galactose.

### More Specific Examples of the Cream Product

In the example given earlier in the text, the procedure was that the inulin and the mother blend liquid were mixed together with more vigorous action to create the hydrocolloid mixture. This is mixed with the cream component itself to be mixed with the mother blend component to make the end product. In these following examples, the same process is used, and the various examples are given primarily to show various ways in which the product could be made.

### Example 1

The three main components and the quantity of each by weight is shown in this example, and it is noted that the cream component is half and half. This end product would be likely used more often as a coffee creamer.

640 g half and half
240 g inulin
140 g water or MFGM or whey

### Example 2

The second example is as follows:
640 g cream
220 g inulin
140 g water or MFGM or whey

The main difference between this second formulation and the first one given immediately above is that instead of having the cream component be 640 g of half and half, rather it is 640 g of cream. This cream product would be more adapted for use as a whipping cream or some other similar application.

### Example 3

This formulation is almost exactly the same as Example 2, except that there is more water and less inulin. This illustrates that a quite viable product could be made with either formulation.

640 g cream

200 g inulin

160 g water or MFGM or whey

### Example 4

This illustrates that the cream product could be combined with an ingredient such as the locust bean gum and so produce a desirable result.

640 g cream

195 g inulin

160 g water of MFGM or whey

5 g locust bean gum

### Dairy Cream Sauce

This shows that a recipe for a dairy cream sauce could have added thereto the cream product of the present invention, and benefit by adding 15 g of soluble fiber and 35% less fat. This illustrates how the cream product of the present invention can be utilized to make cream frosting.

Cream Frosting

1 egg white

¾ cup cream

1 cup powdered sugar

1 cup butter (softened)

1 teaspoon vanilla extract

### Various Advantages of the Cream/Inulin Combination in This Dairy Cream Product

There are a number of advantages or various nutritional and health benefits that can result from use of cream related products, and among these are the following:
i. This food product is relatively lower in cholesterol due to the displacement of the quantity of the cream by the fiber and water, and also for this reason lower in fat content.
ii. The inulin content helps absorption of calcium in humans.
iii. It is also surmised that the soluble dietary fiber content provided by the inulin would be found to aid in binding some of the ingested cholesterol so that it may be sequestered in the digestive system and not enter the blood stream.
iv. Also, present analysis and/or research indicates that a characteristic of inulin is that it promotes the propagation of the bifid bacteria (i.e., a prebiotic to support the probiotic bacteria) in the digestive tract, which would be beneficial to a person's health.
v. This could be attractive possibly to a person who is in the hospital and is fed vitamins or other prescribed nutritional food products or possibly even medicinal products.
vi. Also, the end product of the dairy cream-related product could be mixed with other ingredients beneficially. For example, the end product could be mixed with a Vitamin D component.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A method of making a dairy cream related food product comprising:
a. providing as a first ingredient a quantity of a dairy cream;
b. providing as a second ingredient a quantity of a mother blend comprising a mother blend liquid component of water and/or MFGM buttermilk and/or whey and a quantity of hydrocolloid fiber ingredient that is intimately mixed so that the liquid component be in a colloidal state;
c. mixing the quantity of cream with the second ingredient to form the cream related product.

2. The method as recited in claim 1, wherein a ratio between the quantity of the mother blend liquid component by weight to the quantity of the hydrocolloid fiber component by weight to form the water dietary fiber hydrocolloid mixture is between about 1 to 0.5 and 1 to 4.

3. The method as recited in claim 2, wherein said ratio is between about 1 to 1 to 1 to 2.

4. The method as recited in claim 3, wherein said ratio is between about one to one and about one to one and a half.

5. The method as recited in claim 1, wherein said hydrocolloid fiber component comprises one or more of the following fibers either alone or in combination with one another, said fibers comprising:
Arabic gum
Algin
Bensal
Locust bean tara
Karaya
Guar
Oat
Ghatti
Guince
Sapote
Watsonia
Tamarind
Psyllium
Tragacanth
Xanthan
Furcelleran
Dextran
Chondritin sulfate
Chitosan
Xylan
Propol
Carrageenan
Agar
Pectin

6. The method as recited in claim 1, wherein said hydrocolloid fiber component comprises one or more of the following dietary fibers either alone or in combination with one another, namely, inulin, locust bean gum, guar, xanthan, psyllium, and pectin.

7. The method as recited in claim 1, wherein said hydrocolloid fiber component comprises at least about one half inulin.

8. The method as recited in claim 1, wherein said hydrocolloid fiber component comprises predominately inulin, ranging from all inulin to at least about three-quarters inulin.

9. The method as recited in claim 1, wherein the dairy cream is provided by providing cream taken from milk of a mammal and adding another ingredient comprising one or more of a prebiotic (i.e., food of life) which feed the probiotic bacteria found in the digestive tract, other health enhancing components to said dairy cream, and then mixing the dairy cream with the second ingredient to provide a health enhanced product as a health enhancing dairy cream product.

10. The method as recited in claim 1, further comprising providing said quantity of water component at least in part as a quantity of buttermilk MFGM that it is mixed with the dairy cream.

11. A dairy cream related food product comprising:
a. a first ingredient which comprises a quantity of a dairy cream;
b. a second ingredient comprising a quantity of a mother-blend comprising a mother blend liquid component of water and/or MFGM buttermilk and/or whey and a quantity of a hydrocolloid fiber ingredient that is intimately mixed with the mother blend liquid component so that the mother blend is in a colloidal state;
c. said quantity of dairy cream being mixed with the second ingredient to form the cream related product.

12. The dairy cream related food product as recited in claim 11, wherein a ratio between the quantity of the mother blend liquid component by weight to the quantity of the hydrocolloid fiber component by weight to form the second ingredient is between about 1 to 0.5 and 1 to 4.

13. The dairy cream related food product as recited in claim 12, wherein said ratio is between about 1 to 1 to 1 to 2.

14. The dairy cream related food product as recited in claim 13, wherein said ratio is between about one to one and about one to one and a half.

15. The dairy cream related food product as recited in claim 11, wherein said hydrocolloid dietary fiber component comprises one or more of the following fibers either alone or in combination with one another, said dietary fibers comprising:
Arabic gum
Algin
Bensal
Locust bean tara
Karaya
Guar
Oat
Ghatti
Guince
Sapote
Watsonia
Tamarind
Psyllium
Tragacanth
Xanthan
Furcelleran
Dextran
Chondritin sulfate
Chitosan
Xylan
Propol
Carrageenan
Agar
Pectin

16. The dairy cream related food product as recited in claim 11, wherein said hydrocolloid fiber component comprises at least one or more of the following dietary fibers either alone or in combination with one another, namely, inulin, locust bean gum, guar, xanthan, psyllium, and pectin.

17. The dairy cream related food product as recited in claim 11, wherein said hydrocolloid fiber component comprises at least one half inulin.

18. The dairy cream related food product as recited in claim 11, wherein said hydrocolloid fiber component comprises predominately inulin, and ranging from all inulin to at least about three-quarters inulin.

19. The dairy cream related food product as recited in claim 11, wherein the dietary cream is provided by providing cream taken from milk of a mammal and adding another ingredient comprising one or more of a prebiotic (i.e., food of life) which feed the probiotic bacteria found in the intestinal tract, and/or other health enhancing components to said dairy cream component, and then mixing the dairy cream with the second ingredient to provide a health enhanced dairy cream component which is combined with the product as a health enhancing dairy cream product.

20. The dairy cream food product as recited in claim 11, further comprising providing said quantity of said mother blend liquid component as at least in part a quantity of buttermilk MFGM that is mixed with the dairy cream.
